(19) United States
(12) Patent Application Publication
(10) Pub. No.: US 2024/0421990 A1
(43) Pub. Date: Dec. 19, 2024

(54) METHOD AND SYSTEM FOR SYNCRONIZING ENCRYPTION DATA FOR A VEHICLE

(71) Applicant: Bayerische Motoren Werke Aktiengesellschaft, Muenchen (DE)

(72) Inventor: Markus Walter, Poecking (DE)

(21) Appl. No.: 18/705,796

(22) PCT Filed: Sep. 28, 2022
(86) PCT No.: PCT/EP2022/076905

§ 371 Date: Apr. 29, 2024

(30) Foreign Application Priority Data
Nov. 15, 2021 (DE) 10 2021 129 693.5

(51) Int. Cl. H04L 9/12; H04L 9/08

(52) U.S. Cl. CPC H04L 9/12; H04L 9/0825

(57) ABSTRACT

A method is disclosed for synchronizing first encryption data between a first mobile device and a second mobile device. The method includes generating the first encryption data at the first mobile device, generating second encryption data at the second mobile device, and transmitting the second encryption data to a first network component in order to be retrieved by the first mobile device. The method further includes encrypting the first encryption data based on the second encryption data to obtain encrypted first encryption data, and transmitting the encrypted first encryption data to a second network component to be retrieved by the second mobile device. Additionally, the method includes obtaining encrypted first encryption data from the second network component at the second mobile device, and decrypting the encrypted first encryption data based on the second encryption data in order to obtain decrypted first encryption data at the second mobile device.

### CROSS-REFERENCE TO RELATED APPLICATIONS

The present application is the U.S. national phase of PCT Application No. PCT/EP2022/076905 filed on Sep. 28, 2022, which claims priority to German patent application No. 10 2021 129 693.5 filed on Nov. 15, 2021, the entire contents of which are incorporated herein by reference.

### FIELD

Exemplary embodiments of the present disclosure relate to a method, to a computer program, to equipment for a mobile device and to a vehicle for synchronizing encryption data between mobile devices, in particular, but not exclusively, to using a plurality of encryptions for the protected or secure exchange of encryption data.

### BACKGROUND

Generally speaking, the encryption of data is a conventional concept for guaranteeing data security and data protection. A plurality of encryption algorithms are already known which can be roughly divided into symmetric and asymmetric encryption methods or cryptosystems. In the case of a symmetric method, the participants use the same key, and, in the case of an asymmetric method, the participants use different keys. In asymmetric methods, for example, a publicly available and a private key are used. The private key is known in each case to one participant only and can be used for the digital signature of data, wherein the signature is then verifiable by the public by means of the public key. The public key can be used to encrypt messages. The key pairs are then chosen such that data encrypted with the public key can be decrypted only with the private key.

In addition, concepts are known which accommodate a plurality of secret user data in a type of data safe which is then protected with a general key, for example a master password. Users must then only remember the general key in order to access the user data. The disadvantage here is that, if the general key becomes known, a plurality of secret user data are compromised.

If data are then to be accessed from a plurality of devices (also referred to as touchpoints), this raises the question of synchronizing the general key, insofar as the intention is to avoid a situation in which a user must repeatedly enter a general key. As a general rule, secrets such as PINs (personal identification numbers) or passwords are less secure if they are intended to be input frequently by users, since there is then a tendency to use secrets that are easy to remember or input.

In view of the foregoing, it would be advantageous to provide an improved concept for synchronizing encryption data.

### SUMMARY

Exemplary embodiments disclosed herein are based on the core concept that security-critical customer information, for example between smartphones and vehicles, can be securely synchronized by means of nested encryption.

Known encryption methods can also be nested. This is based on the core concept that an encryption key (key/secret) can be automatically generated at a first touchpoint that is used and can then be distributed among all following touchpoints using a secure synchronization method. The encryption keys are then stored locally on each touchpoint. If a further touchpoint is added, the encryption key is transferred to it using a defined process. As long as there is a touchpoint on which the key is present (e.g. smartphone, vehicle, smartwatch), the encryption key can always be recovered and synchronized with new touchpoints. The local storage on the touchpoints can, at least in some exemplary embodiments, remove the need for a security-critical central storage of encryption keys in the backend.

Exemplary embodiments can thus offer the advantage that a customer does not need to enter a central encryption key manually. The manual input requires some effort, as a result of which the customer uses a short insecure key, has to remember the key and has to store it once manually at each touchpoint. Exemplary embodiments can spare the customer this effort by synchronizing encryption secrets (key/secret) between different touchpoints.

Exemplary embodiments relate to a method for a first mobile device for synchronizing first encryption data with a second mobile device. The method comprises generating the first encryption data and determining second encryption data. The method further comprises encrypting the first encryption data based on the second encryption data in order to obtain encrypted first encryption data, and transmitting the encrypted first encryption data to a network component in order to be retrieved by the second mobile device. As a result, the first encryption data are not transmitted in clear text and can be retrieved in encrypted form from the network component.

The first encryption data can comprise, for example, a symmetric key, and the second encryption data can comprise an asymmetric key. This ensures that data encrypted with the second encryption key can be decrypted only by a specific device, here the second mobile device.

In some exemplary embodiments, the method can comprise using the first encryption data to encrypt a plurality of personal access data of a user. This can be done e.g. in conjunction with a digital keyring, so that a secure management of a plurality of access data of a user can then take place.

In some exemplary embodiments, determining the second encryption data can comprise obtaining the second encryption data generated by the second mobile device from the network component or from a further network component. Communication of the data for the encryption (keys) and communication of the encrypted data can thus take place via different communication paths, thereby further increasing security.

Determining the second encryption data can comprise, for example, generating the second encryption data, wherein the method further comprises providing the second encryption data to the second mobile device for decryption. This can be advantageous, particularly in the case of key synchronization of physically close components. The transmission takes place e.g. via a first communication path and the provision via a second communication path, wherein the first communication path differs from the second communication path, and wherein the second communication path comprises close-range communication. The close-range communication can take place, for example, by means of optical signals or short-range communication technologies, for example near-field communication, NFC. This can contribute to interception-proof transmission.

Determining the second encryption data can comprise an input of a password by a user. The second encryption data can therefore also be secured by means of a password.

Exemplary embodiments also provide a method for a second mobile device for synchronizing first encryption data with a first mobile device. The method comprises generating second encryption data and transmitting the second encryption data to a first network component. The method further comprises obtaining encrypted first encryption data from a second network component and decrypting the encrypted first encryption data based on the second encryption data in order to obtain decrypted first encryption data. The first encryption data can thus be made available to the second mobile device.

In further exemplary embodiments, the method can further comprise checking whether first encryption data are available to the second mobile device, and carrying out the remaining method if no first encryption data are available to the second mobile device. In this respect, a synchronization can be performed on demand. The check can be carried out, for example, if a user logs in on the second mobile device or a user profile of the user is activated. This ensures that first encryption data are present following user login.

Exemplary embodiments also provide a method for synchronizing first encryption data between a first and a second mobile device. The method comprises the methods described above for the first and the second mobile device. The first mobile device can be a vehicle or a mobile radio device of a user, and the second mobile device can similarly be a vehicle or a mobile radio device of a user.

Exemplary embodiments provide a computer program to carry out one of the methods described herein when the computer program runs on a computer, a processor or a programmable hardware component.

A further exemplary embodiment comprises equipment for a mobile device for synchronizing encryption data. The equipment comprises one or more interfaces for communicating with other network components, and a control module which is designed to carry out at least one of the methods described herein. Exemplary embodiments additionally provide a vehicle having a mobile device as described herein.

### BRIEF DESCRIPTION OF THE DRAWINGS

Exemplary embodiments are explained in detail below with reference to the attached figures, in which:

FIG. 1 shows a schematic view of an exemplary embodiment of a method for a first mobile device for synchronizing first encryption data with a second mobile device;

FIG. 2 shows a schematic view of an exemplary embodiment of a method for a second mobile device for synchronizing first encryption data with a first mobile device;

FIG. 3 shows a block diagram of an exemplary embodiment of equipment for a mobile device, and an exemplary embodiment of a vehicle;

FIG. 4 shows a schematic view of a key synchronization in one exemplary embodiment;

FIG. 5 shows a schematic view of a key recovery in one exemplary embodiment;

FIG. 6 shows a schematic view of a key recovery using an optical code in one exemplary embodiment; and

FIG. 7 shows a schematic view of a key recovery by means of a password in one exemplary embodiment.

Different exemplary embodiments will now be described in more detail with reference to the attached drawings in which some exemplary embodiments are shown. The thickness dimensions of lines, layers and/or regions may be shown in exaggerated form in the figures for the sake of clarity.

### DESCRIPTION

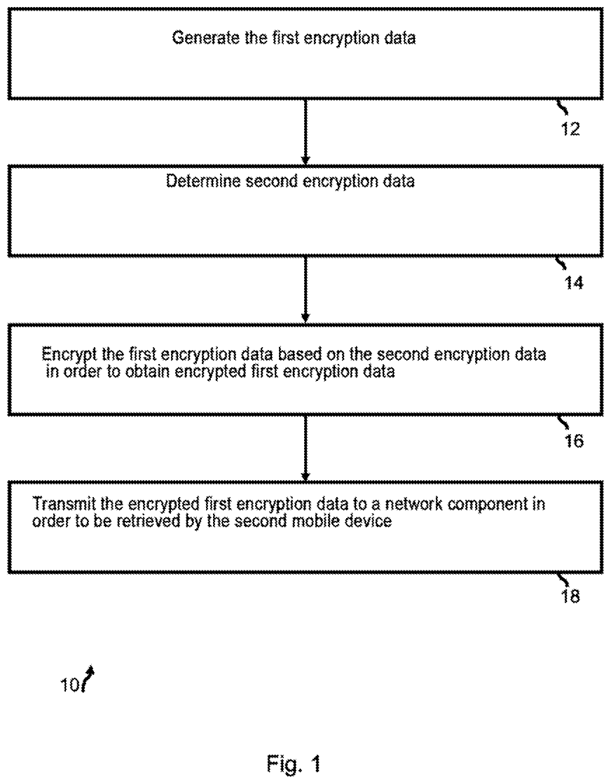

FIG. 1 illustrates a schematic view of a method 10 for a first mobile device for synchronizing first encryption data with a second mobile device. The method 10 comprises generating 12 the first encryption data and determining 14 second encryption data. In addition, the method 10 comprises encrypting 16 the first encryption data based on the second encryption data in order to obtain encrypted first encryption data. The method 10 further comprises transmitting 18 the encrypted first encryption data to a network component in order to be retrieved by the second mobile devices.

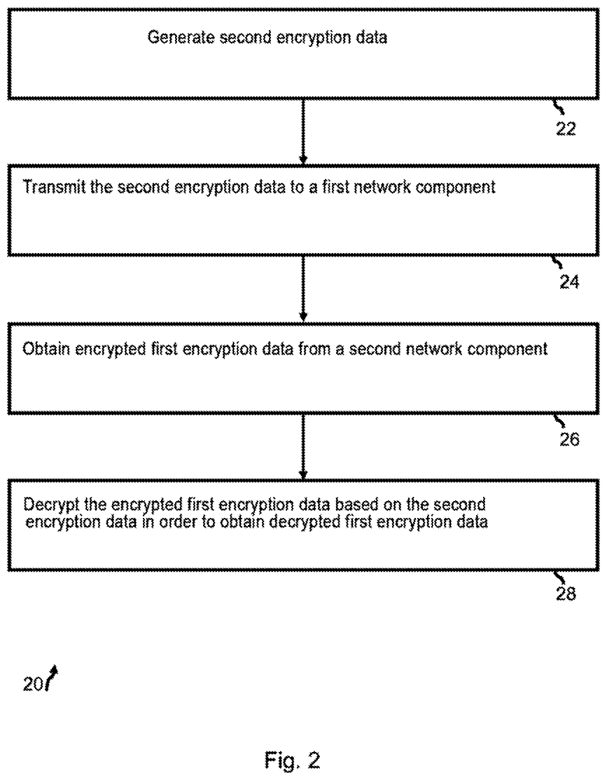

FIG. 2 shows a schematic view of an exemplary embodiment of a method 20 for a second mobile device for synchronizing first encryption data with a first mobile device. The method 20 comprises generating 22 second encryption data and transmitting 24 the second encryption data to a first network component. The method 20 additionally comprises obtaining 26 encrypted first encryption data from a second network component and decrypting 28 the encrypted first encryption data based on the second encryption data in order to obtain decrypted first encryption data.

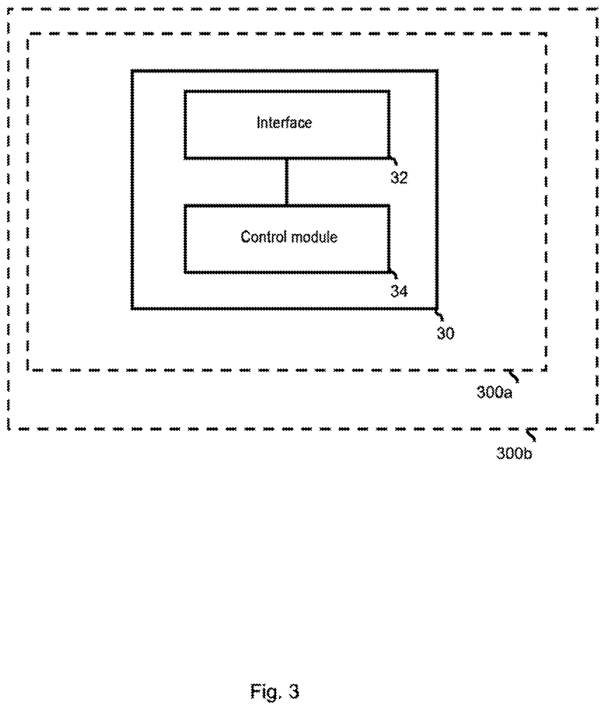

FIG. 3 shows a block diagram of an exemplary embodiment of equipment 30 for a mobile device 300a, and an exemplary embodiment of a vehicle 300b. The equipment 300 for a mobile device 300a for synchronizing encryption data comprises one or more interfaces 32 for communicating with other network components. The equipment 30 further comprises a control module 34 which is designed to carry out at least one of the methods 10, 20 described herein. Control modules are commonly used in vehicles or in association with vehicle testing. Control modules (which may also be referred to herein as “controllers,” “control units,” “processors” or “microprocessors”) include circuits (e.g., integrated circuits) that contain typical functionality of central processing units (CPU) and are configured to perform various calculations and analysis based on manufacturer programming and/or circuit components. Examples of controllers used in vehicles include any of various Engine Control Units (ECNs), communication control units, and other controllers commonly used by different manufacturers in modern automobiles. Further exemplary embodiments are a mobile device 300a having equipment 30, and a vehicle 300b having a mobile device 300a having equipment 30.

The one or more interfaces 32 can correspond, for example, to one or more inputs and/or one or more outputs for receiving and/or transmitting information, e.g. in digital bit values, based on a code, within a module, between modules, or between modules of different entities. The at least one interface 32 can be designed, for example, to communicate with other network components via a (radio) network or a local connection network.

In exemplary embodiments, the control module 34 can correspond to any controller or processor or programmable hardware component. The control module 34 can also be implemented, for example, as software which is programmed for a corresponding hardware component. The control module 34 can thus be implemented as programmable hardware having correspondingly adapted software. Any processors, such as digital signal processors (DSPs), can be used. Exemplary embodiments are not restricted to a specific type of processor. Any processors or a plurality of processors are conceivable for implementing the control module 34.

In at least some exemplary embodiments, the vehicle 300b can correspond, for example, to a land vehicle, a watercraft, an aircraft, a rail vehicle, a road vehicle, an automobile, an omnibus, a motorcycle, an off-road vehicle, a motor vehicle or a truck.

The mobile device can, for example, be a smartphone, a tablet, a laptop or other user terminal device, which can also be integrated into a vehicle.

In some exemplary embodiments, the first encryption data can comprise, for example, a symmetric key, and the second encryption data can comprise, for example, an asymmetric key. The first encryption data are used, for example, to encrypt a plurality of personal access data of a user.

Exemplary embodiments provide a concept or mechanisms for synchronizing, for example, a symmetric encryption key between different touchpoints/mobile devices (e.g. vehicles and smartphones), said key being used for encrypting and decrypting data, for example for encrypting and decrypting a digital keyring. Important personal information (e.g. PINs, passwords, authentication tokens of third-party providers) can be stored and secured in a digital keyring.

For this purpose, in one exemplary embodiment, a symmetric encryption key is securely synchronized between all touchpoints/mobile devices (e.g. in order to add a password to the digital keyring in a smartphone and automatically in all vehicles used by a user). A symmetric key (first encryption data, symmetricEncryptionKey), for example, is generated automatically at the touchpoint/mobile device (the user does not have to create or remember a password) and is then stored locally on all touchpoints/mobile devices.

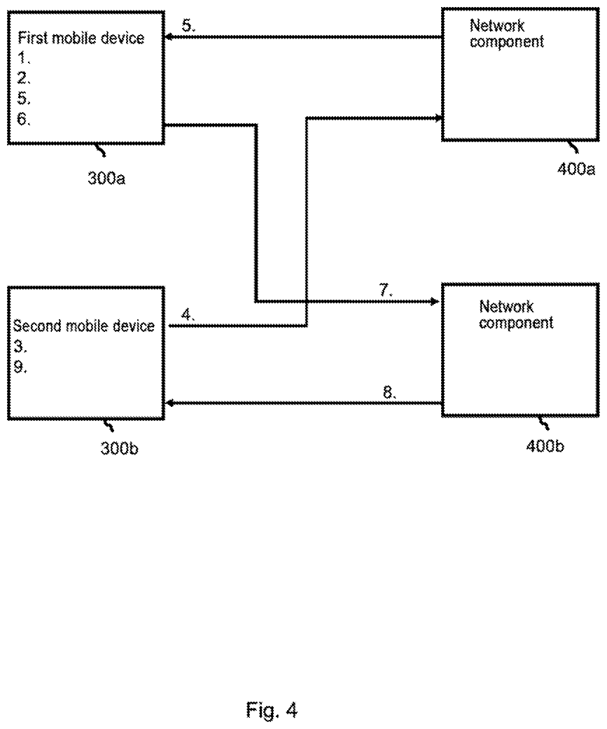

FIG. 4 shows a schematic view of a key synchronization in one exemplary embodiment. FIG. 4 shows a first mobile device 300a, a second mobile device 300a and two network components 400a and 400b.

The sequence in this exemplary embodiment is then as follows. First, in step 1, a symmetric key is generated on the first mobile device 300a (first encryption data) and is stored in step 2. In parallel, in a step 3, an asymmetric key pair is generated on the second mobile device 300b (second encryption data). In step 4, the public key is then stored on the first network component 400a (e.g. a backend server for storing public keys), together with corresponding identifiers (e.g. a GCID (Global Catalog Identifier) or a Vehicle Identification Number (VIN)). In step 5, the first mobile device 300a can retrieve the public key from the first network component 400a and, in a step 6, can encrypt the symmetric key with the public key (encrypted first encryption data). In this exemplary embodiment, determining 12 the second encryption data comprises obtaining the second encryption data generated by the second mobile device 300b from the network component 400a. In further exemplary embodiments, these encryption data could also be obtained from a different network component (e.g. 400b).

In step 7, the first key encrypted in this way is stored on the second network component 400b which can be implemented, for example, as a backend server provided for this purpose. This can in turn be carried out together with corresponding identifiers (GCID, VIN). In step 8, the second mobile device 300b can then obtain the encrypted data from the second network component 400b and can decrypt it in step 9 with the available private key so that the symmetric key initially generated by the first mobile device is now available to the second mobile device 300b without ever having been communicated in unencrypted form.

In exemplary embodiments, the first mobile device 300a can be a vehicle or a mobile radio device of a user, and the second mobile device 300b can similarly be a vehicle or a mobile radio device of a user.

The methods shown essentially work with different combinations of touchpoints/mobile devices (smartphone, vehicle). Some examples are:
i 300a: smartphone, 300b: vehicle,
ii 300a: smartphone, 300b: smartphone,
iii 300a: vehicle, 300b: smartphone; and
iv 300a: vehicle, 300b: vehicle.

The method shown in FIG. 4 can therefore begin, for example, according to case i, in which the first mobile device 200a is a smartphone, and the second mobile device 300b is a vehicle. This can entail additional preconditions, such as, for example, a dependence on the smartphone.

If, for example, the user logs in on the smartphone, a symmetric encryption key is automatically created (step 1). This symmetric encryption key is stored on the smartphone (step 2). A new key synchronization may be in order, for example, in the case of a new vehicle configuration or a new vehicle. When the user logs in on the new vehicle, a symmetric key pair is then created for the transport of the key (step 3). The public key is stored in the backend 400a (step 4) and is then transmitted to the smartphone 300a (step 5). The smartphone 300a encrypts the symmetric key (symmetric encryption key) with the public key (step 6) and transmits it, encrypted in this way, to the backend 400b (step 7). The encrypted symmetric key can then be transmitted to the vehicle 300b, where it can then be decrypted using the private key. From then on, the symmetric key can be used for the digital keyring. Components in this exemplary embodiment are e.g. a smartphone 300a in which the push mechanism is activated in step 5, and a vehicle 300b which enables HTTP requests and provides the use of a system as a backend service for the vehicle push. A further component would be the backend 400a, 400b which can be implemented in one component or in separate components.

From the perspective of a user, the method can be carried out whenever said user logs in on a corresponding application or a new vehicle is intended to be registered.

During an initial configuration, for example, a user logs in on a corresponding application (app), e.g. an app of the manufacturer of the vehicle of the user. Additionally or alternatively, the method can also be carried out during the login on a new/different vehicle.

The user can also receive a push notification on his smartphone and can be prompted to confirm the use of a DKR on the vehicle with a specific VIN. A corresponding confirmation can then be performed by the user. The keyring (DKR) is then ready for use in the vehicle within a short time period (e.g. a few seconds).

Exemplary embodiments for the key recovery are explained below. Since the symmetric encryption key is stored locally on all touchpoints/mobile devices (vehicle and smartphone), the key can be recovered as long as it is available on a touchpoint/mobile device.

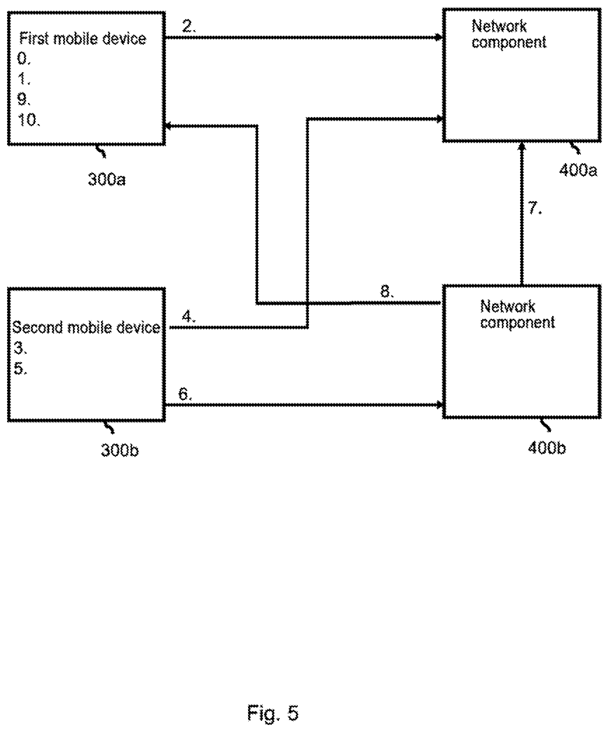

At least in some exemplary embodiments, if the symmetric key (symmetricEncryptionKey) is not available at any touchpoint, the key can no longer be recovered and the DKR is recreated. In other exemplary embodiments, the key may possibly still be hidden by a network component. A recovery takes place, for example, from the vehicle via the backend. FIG. 5 shows a schematic view of a key recovery in one exemplary embodiment. In the present exemplary embodiment, the mobile device 300a is a smartphone and the mobile device 300b is a vehicle.

In the present exemplary embodiment, the recovery begins in step 0 when the user logs in on a new smartphone 300a for which no symmetric encryption key is available. A logic exists, for example, which reads information, for example, from the backend indicating whether a symmetric key already exists somewhere. If so, an asymmetric key pair (second encryption data) is generated in a first step and the public key is stored on the network component 400a in a second step. Determining 14 the second encryption data comprises generating the second encryption data, and the method 10 further comprises providing the second encryption data to the second mobile device 300b for decryption. In this exemplary embodiment, the provision takes place indirectly via the network component 400a. In some exemplary embodiments, the method can be carried out in such a way that the user does not notice it. The entire recovery process can then take place without user interaction.

In some exemplary embodiments, the user would perhaps like to open a connection screen or connection window without having a symmetric encryption key. This screen should then be blocked. Instead, a notice can appear indicating how the recovery process can be completed. This could be done, for example, by restarting the vehicle. A profile change could possibly even take place, wherein it should be ensured here that this does not result in a deletion of the profile and the deletion of the keys on the vehicle.

In the exemplary embodiment shown in FIG. 5, the vehicle 300b is started and the user profile is activated in step 3. The vehicle 300b retrieves the public key (publicKey) from the network component 400a in step 4. The trigger on the vehicle 300b can, for example, be the activation of the user profile. The vehicle 300b then searches (each time again) for a publicKey in the backend 400a. If the vehicle 300b finds a public key in the backend 400a, a recovery is deemed to be requested. This can result in an additional backend request for a user change. In exemplary embodiments, other possibilities for a trigger are conceivable if this regular request is to be avoided, e.g. the user can confirm the recovery of the key from the vehicle manually via a corresponding interface.

In step 5, the vehicle encrypts the symmetric key (first encryption data) with the public key and stores the encrypted key (encryptedSymmetricEncryptionKey) in the backend 400b in step 6. From there, the public key is then deleted in step 7 since it is no longer required. In step 8, the backend 400b transmits the encrypted key (encryptedSymmetricEncryptionKey) to the smartphone 300a, e.g. by means of the push mechanism, and deletes the encrypted key (encryptedSymmetricEncryptionKey) from the backend 400b following successful transmission. In step 9, the encryptedSymmetricEncryptionKey is then decrypted and the symmetric encryption key can be stored once more on the smartphone 300a in step 10.

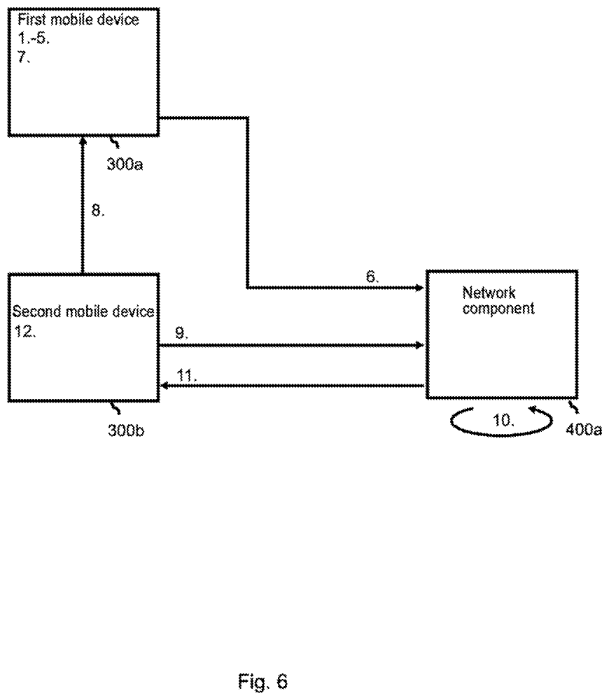

A recovery of a key from the vehicle by means of a QR code is described below based on the exemplary embodiment shown in FIG. 6. FIG. 6 shows a schematic view of a key recovery by means of an optical code in one exemplary embodiment. Two mobile devices 300a, 300b are shown on the left side, wherein it is assumed here that the mobile device/touchpoint 300a corresponds to a vehicle and that the mobile device/touchpoint 300b corresponds to a smartphone. In addition, FIG. 6 shows on the right side a network component 400b which is used for temporary storage.

The method assumes that, in a first step, a user has activated his smartphone 300b in the vehicle 300a and that a symmetric key is stored in the vehicle 300a. It can then be assumed that the user starts or requests the key recovery in step 3, e.g. by means of a user input on the vehicle 300a or on his smartphone 300b. In step 4, the vehicle 300a then generates an asymmetric key pair and encrypts the existing symmetric key with the generated public key in step 5. The encrypted key thus obtained (first encryption data encrypted with the second encryption data) can then be deposited or stored in the network component 400a (step 6).

In the present exemplary embodiment, the private key is then transmitted directly from the vehicle 300a to the smartphone 300b. In this exemplary embodiment also, determining 14 the second encryption data therefore comprises generating the second encryption data (here in the vehicle), and the method 10 further comprises providing the second encryption data to the second mobile device 300b for decryption. In this exemplary embodiment, the second encryption data are provided directly to the mobile device 300b. The encrypted first encryption data are transmitted 18 via a first communication path and the second encryption data are provided via a second communication path. The first communication path differs from the second communication path. In addition, the second communication path comprises close-range communication. Close-range communication of this type can be implemented, for example optically or by means of short-range radio systems such as Bluetooth or NFC. In the present exemplary embodiment, a QR (Quick Response) code is used which is displayed by the vehicle 300a and is read with the camera of the smartphone 300b in step 8.

In a further step 9, the encrypted data can then be requested from the network component 400a. The latter can check in a step 10 whether an identifier of the vehicle transmitted with the request also matches an identifier of the encrypted data. It is thus possible to verify that the request and the requested data relate to the same vehicle 300a. This can be done, for example, by means of a GCID or VIN. If the verification is successful, the data can be transmitted to the smartphone 300b and can be deleted on the network component 400a in step 11. The smartphone 300b can then decrypt the symmetric key with the private key obtained from the vehicle 300a and can use said symmetric key (step 12).

The following security-related aspects can further be considered. The recovery of the symmetric encryption key is not carried out very frequently. The procedure can therefore be triggered manually by the customer in the vehicle (step 3). In further exemplary embodiments, the time allowed to complete the process can be limited (e.g. <2 min). The data can otherwise be deleted automatically in the backend 400a. The user should generally be present in the vehicle 300a in order to scan the QR code (step 8) In some exemplary embodiments, the recovery can be performed only by a vehicle on which the user is logged in, on a smartphone on which the user is logged in with the same GCID, and this can be checked by the backend 400a in step 10. Even if the private key has been intercepted, it is nevertheless useless without access to the encrypted data (encryptedSymmetricEncryptionKey) in the backend 400a. Such access to the “encryptedSymmetricEncryptionKey” encrypted data can be granted, for example, only by means of an application of the manufacturer provided for this purpose with a logged-in user.

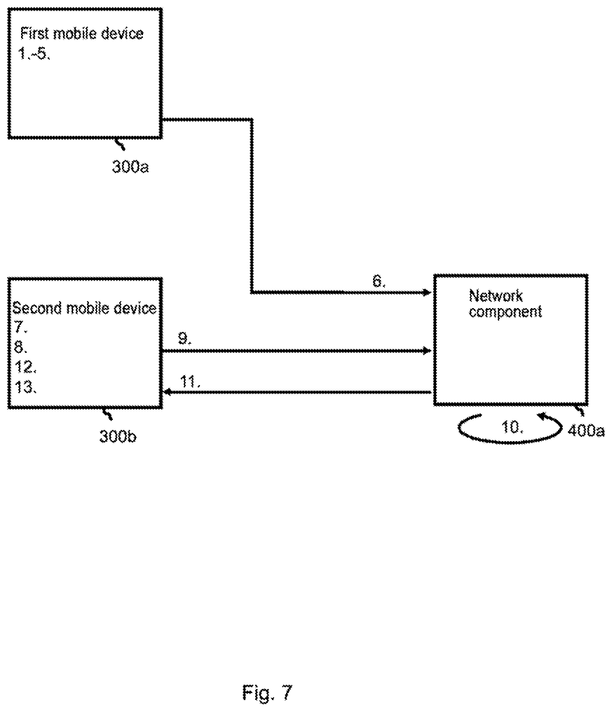

FIG. 7 shows a schematic view of a key recovery using a password in a further exemplary embodiment. FIG. 7 again shows two mobile devices 300a, 300b on the left side, and a network component 400a on the right side. The two mobile devices correspond, for example, to two smartphones 300a, 300b. In this exemplary embodiment, a recovery is performed by the backend by means of a user password. As an additional option, some exemplary embodiments can accordingly offer the facility to recover a symmetric encryption key by means of a password. The core concept behind this is that the symmetric key (symmetricEncryptionKey) is generated by the smartphone 300a following the login with the user data (username, password). The username and password can be used to generate a password-based key (passwordBasedEncryptionKey, symmetric) which is used to encrypt the symmetric encryption key and store it permanently in the backend.

As shown in FIG. 7, the user logs in to the application of the manufacturer in step 1. The password-based key is then generated in step 2. The symmetric key is generated in step 3 and is stored in the mobile device 300a (step 4). The symmetric key can then be encrypted with the password-based key (step 5) and transmitted to the network component 400a (step 6). In this exemplary embodiment, determining 14 the second encryption data comprises an input of a password by a user.

Steps 1-6 in this exemplary embodiment describe additional/optional steps which are added during the initial generation of the symmetricEncryptionKey. The user logs in on the second mobile device 300b (e.g. a different smartphone) in step 7, and the password is input (step 8). In some exemplary embodiments, a check can first be carried out to determine whether first encryption data are available to the second mobile device 300b, and the remaining method can then be carried out if no first encryption data are available to the second mobile device 300b. A check of this type can be carried out, for example, if a user logs in on the second mobile device or a user profile of the user is activated.

In step 9, the password-encrypted key can be requested from the network component 400a. A verification of the request, i.e., for example, a check to determine whether the GCID in the request from the smartphone 300b (ID token also) corresponds to the GCID of the encrypted data, is carried out on the network component 400a in step 10. If so, the password-encrypted symmetric key can be transmitted in step 11 from the network component 400a to the mobile device 300b and can be decrypted by means of the password (step 12) and stored there (step 13).

Steps 7-13 describe the recovery mechanism by the backend 400a. The touchpoint 300b can, for example, be a different smartphone or a device on which the app of the manufacturer has been installed. At least in some exemplary embodiments, the vehicle may therefore not be involved, and the symmetric encryption key can be recovered directly by the backend 400a.

If the user password changes, the key can be recovered, if necessary with the involvement of the vehicle. It can be assumed that the user password is not frequently changed, so that the method described with reference to FIG. 7 will help in a high percentage of cases without the vehicle having to be involved. If the user password is changed, the key can be transmitted back from the vehicle, or the digital keyring (DKR) is reset.

In further exemplary embodiments, in order to increase the availability of a valid “passwordbasedEncryptedSymmetricEncryptionKey” in the backend 400a, the user can be forced to log in to the application of the manufacturer once more after each password change. If he logs in once more to an application in which the unencrypted symmetricEncryptionKey is still available, the password-based, encrypted symmetric encryption key can be updated in the backend 400a. As a result, the recovery rate would be substantially increased using this mechanism. However, there may still be cases in which this does not work and the password-based, encrypted symmetric encryption key is invalid after a password change. In this case, the alternatives already described can be used.

Exemplary embodiments also provide a method for synchronizing first encryption data between a first and a second mobile device 300a, 300b, comprising a method from the perspective of the first mobile device 300a and a method from the perspective of the second mobile device 300b, according to the description above.

Further exemplary embodiments are computer programs to carry out one of the methods described herein when the computer program runs on a computer, a processor or a programmable hardware component. Exemplary embodiments of the disclosure can be implemented in hardware or software, depending on specific implementation requirements. The implementation can be carried out using a digital storage medium, for example a floppy disk, a DVD, a Blu-Ray disc, a CD, a ROM, a PROM, an EPROM, an EEPROM or a FLASH memory, a hard disk or other magnetic or optical memory on which electronically readable control signals are stored which interwork or can interwork with a programmable hardware component in such a way that the respective method is carried out.

A programmable hardware component can be formed by a processor, a computer processor (CPU=Central Processing Unit), a graphics processor (GPU=Graphics Processing Unit), a computer, a computer system, an application-specific integrated circuit (ASIC), an integrated circuit (IC), a system on chip (SOC), a programmable logic element or field-programmable gate array (FPGA) with a microprocessor.

The digital storage medium can therefore be machine-readable or computer-readable. Some exemplary embodiments therefore comprise a data medium which has electronically readable control signals which are capable of interworking with a programmable computer system or programmable hardware component in such a way that one of the methods described herein is carried out. One exemplary embodiment therefore comprises a data medium (or a digital storage medium or a computer-readable medium) on which the program is recorded in order to carry out one of the methods described herein.

Generally speaking, exemplary embodiments of the present disclosure can be implemented as a program, firmware, computer program or computer program product having a program code, or as data, wherein the program code or the data is/are effective in carrying out one of the methods when the program runs on a processor or a programmable hardware component. The program code or the data can be stored, for example, on a machine-readable medium or data medium. The program code or the data can be present, inter alia, as source code, machine code or byte code, or as different intermediate code.

The exemplary embodiments described above merely represent an illustration of the principles of the present disclosure. Modifications and variations of the arrangements and details described herein will obviously be evident to other persons skilled in the art. The disclosure is therefore intended to be restricted only by the protective scope of the patent claims below, and not by the specific details which have been presented herein based on the description and the explanation of the exemplary embodiments.

### REFERENCE SIGN LIST

10 Method for a first mobile device for synchronizing first encryption data with a second mobile device
12 Generate the first encryption data
14 Determine second encryption data
16 Encrypt the first encryption data based on the second encryption data in order to obtain encrypted first encryption data
18 Transmit the encrypted first encryption data to a network component in order to be retrieved by the second mobile device
20 Method for a second mobile device for synchronizing first encryption data with a first mobile device
22 Generate second encryption data
24 Transmit the second encryption data to a first network component
26 Obtain encrypted first encryption data from a second network component
28 Decrypt the encrypted first encryption data based on the second encryption data in order to obtain decrypted first encryption data
30 Equipment for a mobile device for synchronizing encryption data
32 One or more interfaces for communicating with other network components
34 Control module
300a Mobile device/touchpoint/vehicle/smartphone
300b Mobile device/touchpoint/vehicle/smartphone
400a Network component/backend/server
400b Network component/backend/server

1.-15. (canceled)

16. A method for a first mobile device for synchronizing first encryption data with a second mobile device, the method comprising:
generating the first encryption data;
determining second encryption data;
encrypting the first encryption data based on the second encryption data in order to obtain encrypted first encryption data; and
transmitting the encrypted first encryption data to a network component in order to be retrieved by the second mobile device.

17. The method as claimed in claim 16, wherein the first encryption data comprise a symmetric key, and wherein the second encryption data comprise an asymmetric key.

18. The method as claimed in claim 17, further comprising using the first encryption data to encrypt a plurality of personal access data of a user.

19. The method as claimed in claim 18, wherein determining the second encryption data comprises obtaining the second encryption data generated by the second mobile device from the network component or from a further network component.

20. The method as claimed in claim 19, wherein determining the second encryption data comprises generating the second encryption data, wherein the method further comprises providing the second encryption data to the second mobile device for decryption.

21. The method as claimed in claim 20, wherein the transmission takes place via a first communication path and the provision via a second communication path, wherein the first communication path differs from the second communication path, and wherein the second communication path comprises close-range communication.

22. The method as claimed in claim 21, wherein determining the second encryption data comprises an input of a password by a user.

23. The method as claimed in claim 16 wherein the method is carried out by a controller, the controller including a non-transient computer-readable medium comprising instructions which, when executed by the controller, causes the controller to perform the acts of generating, determining, and transmitting.

24. A method for a second mobile device for synchronizing first encryption data with a first mobile device, the method comprising:
generating second encryption data;
transmitting the second encryption data to a first network component;
obtaining encrypted first encryption data from a second network component; and
decrypting the encrypted first encryption data based on the second encryption data in order to obtain decrypted first encryption data.

25. The method as claimed in claim 24, further comprising, prior to obtaining first encryption data from the second network component, checking whether first encryption data are available to the second mobile device, and when no first encryption data are available to the second mobile device, carrying out the acts of obtaining encrypted first encryption data and decrypting the encrypted first encryption data.

26. The method as claimed in claim 25, further comprising carrying out the act of checking when a user logs in on the second mobile device or a user profile of the user is activated.

27. The method as claimed in claim 24 wherein the method is carried out by a controller, the controller including a non-transient computer-readable medium comprising instructions which, when executed by the controller, causes the controller to perform the acts of generating, transmitting, obtaining and decrypting.

28. A method for synchronizing first encryption data between a first mobile device and a second mobile device, wherein the first mobile device is a vehicle or a smartphone of a user, and wherein the second mobile device is a vehicle or a smartphone of a user, the method comprising:
generating the first encryption data at the first mobile device;
generating second encryption data at the second mobile device;
transmitting the second encryption data to a first network component in order to be retrieved by the first mobile device;
encrypting the first encryption data based on the second encryption data in order to obtain encrypted first encryption data;
transmitting the encrypted first encryption data to a second network component in order to be retrieved by the second mobile device;
obtaining encrypted first encryption data from the second network component at the second mobile device; and
decrypting the encrypted first encryption data based on the second encryption data in order to obtain decrypted first encryption data at the second mobile device.

29. The method as claimed in claim 28, wherein the first encryption data comprise a symmetric key, and wherein the second encryption data comprise an asymmetric key.

30. The method as claimed in claim 29, further comprising using the first encryption data to encrypt a plurality of personal access data of a user.

31. The method as claimed in claim 30, wherein the transmission takes place via a first communication path and the obtaining via a second communication path, wherein the first communication path differs from the second communication path, and wherein the second communication path comprises close-range communication.

32. The method as claimed in claim 28 wherein the first mobile device is a vehicle and the second mobile device is a smartphone of a user.

33. The method as claimed in claim 28 wherein the first mobile device is a smartphone of a user and the second mobile device is a vehicle.

34. The method as claimed in claim 33 wherein the smartphone includes a first controller including a non-transient computer-readable medium comprising instructions which, when executed by the first controller, causes the first controller to perform the acts of generating the first encryption data, encrypting the first encryption data, and transmitting the encrypted first encryption data to a second network component.

35. The method as claimed in claim 34 wherein the vehicle includes a second controller including a non-transient computer-readable medium comprising instructions which, when executed by the second controller, causes the second controller to perform the acts of generating the second encryption data, transmitting the second encryption data to a first network component, and decrypting the encrypted first encryption data.
